(19) United States
(12) Patent Application Publication
(10) Pub. No.: US 2003/0009642 A1
(43) Pub. Date: Jan. 9, 2003

(54) Data storing circuit and data processing apparatus

(76) Inventor: Miyuki Takeshita, Kanagawa (JP)

Correspondence Address: Darryl G. Walker, WALKER & SAKO, LLP, Suite 235, 300 South First Street, San Jose, CA, 95113, US

(21) Appl. No.: 10/174,154

(22) Filed: Jun. 18, 2002

(30) Foreign Application Priority Data
Jun. 21, 2001 (JP) 2001-188250

(51) Int. Cl. G06F 12/00

(52) U.S. Cl. 711/154

(57) ABSTRACT

A data processing apparatus (100) varying width data sizes for a data storing device is disclosed. A data processing apparatus (100) may include a data storage circuit (201), a read/write switch circuit (103), an address generating circuit (104), and a selection signal generating circuit (202). A data storage circuit (201) may include at least one memory array (112), a selecting circuit (211 and 212), a read circuit (214) and a write circuit (213). Selecting circuit (211 and 212) may select a plurality of data bits from a memory array (112) in a first mode and may select N times the plurality of data bits from a memory array (112) in a second mode. In this way, a data storage circuit (201) may be shared by, for example, processors having different data widths.

### TECHNICAL FIELD

The present invention relates to configuration of data widths in general and particularly to selection of N times in width of input data sizes for a data storing circuit.

### BACKGROUND OF THE INVENTION

In a data processing system having a microcomputer or the like, data storage circuits may be connected to a central processing circuit. Various data storage circuits may include a memory array, such as a random access memory (RAM), read only memory (ROM), or the like. A data storage circuit may store data values with a predetermined data-width. A central processing circuit can be a central processing unit (CPU). A central processing unit (CPU) may process data values with a predetermined data-width, such as 8 bits or 16 bits.

Typically, when a data processing apparatus is configured, a central processing unit (CPU) and a data storage circuit may be connected so that both may have a common data-width. However, when two central processing circuits having different data widths are connected to a single data storage circuit (by way of a data bus, for example), a corresponding data width for a data storage circuit may be selected accordingly.

A conventional data processing apparatus for selection of a corresponding data width will now be described in the following FIGS. 5 and 6.

Referring now to FIG. 5, a conventional data processing apparatus for selection of a corresponding data width is set forth and designated by the general reference number 500. Conventional data processing apparatus 500 includes a first data storage circuit 101, a second data storage circuit 102, a read/write switch circuit 103, an address generating circuit 104, and a selection signal generating circuit 105.

A first data storage circuit 101 and a second data storage circuit 102 may each include a RAM array or an Electrically Erasable Programmable Read Only Memory array (EEPROM). A memory array may include rows and columns of memory cells. First and second data storage circuits (101 or 102) store data values.

In addition, first data storage circuit 101 and second data storage circuit 102 receive data values DATA 7-0 and DATA 15-8, respectively, having an 8-bit data width. Data values stored in first and second data storage circuit (101 or 102) can be read upon receiving a read signal RE from a read/write switch circuit 103. First data storage circuit 101 or a second data storage circuit 102 will be described in more detail in FIG. 6.

Read/write switch circuit 103 receives a read enable signal READ_EN and a write enable signal WRITE_EN. Read/write switch circuit 103 selectively activates and outputs a write signal WE or a read signal RE to a first data storage circuit 101 and a second data storage circuit 102. Read/write switch circuit 103 will be described in more detail in FIG. 6.

An address generating circuit 104 is connected to first data storage circuit 101 and second data storage circuit 102. An address generating circuit 104 generates an address AD15-0 for each cell of a memory array in first data storage circuit 101 and second data storage circuit 102. A typical address can be of a 16-bits, for example.

First data storage circuit 101 and second data storage circuit 102 receives an address AD15-0 from an address generating circuit 104. Address AD15-0 is decoded to select a corresponding memory cell on a memory array. Address AD15-0 can be received in parallel with an enable signals, such as a READ_EN or WRITE_EN, by first data storage circuit 101 and a second data storage circuit 102.

Selection signal generating circuit 105 provides a selection signal CS to first data storage circuit 101 and/or second data storage circuit 102. A selection signal from an output CS_H is transmitted to first data storage circuit 101. A selection signal from an output CS_L is transmitted to second data storage circuit 102. In this way, a selection signal generating circuit 105 selectively controls operations in first data storage circuit 101 and/or second data storage circuit 102.

Referring now to FIG. 6, a conventional data storage circuit including a read/write switch circuit is set forth and designated by the general reference number 600. Conventional data storage circuit includes a number of memory arrays 112, an X-decoder 113 and a Y-decoder 114, a read circuit 116 and a write circuit 115.

Memory array 112 includes a number of memory cells 111. Typically, a memory cell 111 on a conventional data storage circuit 600 may have a 2,048×32 layout, 2048 rows and 32 columns, for example. Each memory cell 111 has an address value ranging from 0000 to FFFF. Each address value can correspond to a point value having both an X-axis and Y-axis indications. In this example, memory cells 111 are memory cell groups selectable by an address value. Each memory cell group 111 stores an 8-bit data value.

An X-decoder 113 and a Y-decoder 114 respectively activates a row and a column to select a memory cell 111 on a memory array 112. X-decoder 113 and Y-decoder 114 are connected between memory array 112 and an address generating circuit 104 (FIG. 6).

X-decoder 113 and Y-decoder 114, respectively, receive an input of an address value from address generating circuit 104 and decode it to an X-axis value and a Y-axis value, respectively. An X-decoder 113 and a Y-decoder 114 may then output decoded signals that activate a row and a column to a cell selecting circuit to select a memory cell 111 with a corresponding address.

X-decoder 113 and Y-decoder 114 also receives a selection signal CS generated by selection signal generating circuit 105. In this way, either first data storage circuit 101 or a second data storage circuit 102 is activated may depend upon a selection signal that selects either a first data storage circuit 101 or a second data storage circuit 102 and a memory cell 111 from the selected data storage circuit (101 and 102).

For example, an address generating circuit 104 in FIG. 5 may generate and provide an address value to an X-decoder 113 and a Y-decoder 114 in a first or a second data storage circuit 101 or 102. X-decoder 113, for example, receives an 11-bit value AD[15:5] and decodes it to select one of 2048 rows. A Y-decoder 114 receives and decodes a 5-bit value AD[4:0] to select one of 32 columns. Thus, a memory cell with a corresponding row and column is selected accordingly for a read and/or write operation, or the like.

Conventional data storage circuit 600 further includes a conventional write circuit 115 and a read circuit 116. Conventional write circuit 115 and read circuit 116 write data into and read data from, respectively, a memory cell 111 in memory array 112. Depending upon whether a write-enable signal, WRITE_EN or a read-enable signal, READ_EN, is enabled, a write circuit 115 or a read circuit 116 receives a write command WE or a read command RE. A write or read operation is thus activated and data values are written into or read from a memory cell 111.

Referring once again to FIG. 5, a read/write operation performing on first data storage circuit 101 or second data storage circuit 102 are controlled by a read/write switching circuit 103. Read/write switching circuit 103 may output either a read or a write signal to control a data storage circuit. First data storage circuit 101 or a second data storage circuit 102 each process a data value of 8-bit wide.

Having described a conventional data storage circuit, various conventional operations will now be described.

A conventional operation includes three kinds of operation modes, a first 8-bit mode, a second 8-bit mode and a 16-bit mode. Each of the three operation modes involves different data storage circuits.

A first 8-bit operation mode involves only a first data storage circuit 101. Second data storage circuit 102 is not involved. Data values of an 8-bit width DATA 7-0 is received and processed at first data storage circuit 101.

A second 8-bit operation mode involves only second data storage circuit 102. First data storage circuit 101 is not involved. Data values of an 8-bit width DATA 15-8 is received and processed at second data storage circuit 102.

A 16-bit operation mode involves both first data storage circuit 101 and second data storage circuit 102. Both data values of DATA 7-0 and DATA 15-8 are received and processed at first data storage circuit 101 and second data storage circuit 102 simultaneously. In this way, a data value of a 16-bit width with each of two 8-bit data values is processed in two data storage circuits at the same time. As a result, a 16-bit select output may be generated.

Such use of a plurality of data widths is needed, for example, when two CPUs, or the like, having different data widths are sharing the same memory. For example, a first CPU can have an 8-bit data path and a second CPU can have a 16-bit data path.

However, a drawback to a conventional data processing apparatus becomes apparent when data values of more than 8-bit width are processed. When a data value of 16-bit width is received, an individual data storage circuit is not sufficient to process a data value of a 16-bit width. A combination of both a first data storage circuit 101 and a second data storage circuit 102 is thus necessary to process data values of 16-bit width. The parallel use of both data storage circuit 101 and 102 increases complexity and inefficiency of a data processing circuit. Also, the use of both data storage circuits 101 and 102 uses more board space and increases costs.

It is therefore desirable to arrive at a data process apparatus that may be capable of processing varying width data more efficiently.

### SUMMARY OF THE INVENTION

According to the embodiments, a data processing apparatus may include a data storage circuit, a read/write switch circuit, an address generating circuit, and a selection signal generating circuit. Unlike a conventional data processing apparatus, a data processing apparatus according to a first embodiment may include a single data storage circuit. A single data storage circuit may include at least one memory array, a selecting circuit, a read circuit and a write circuit. A selecting circuit may select a plurality of data bits from a memory array in a first mode and may select N times the plurality of data bits from a memory array in a second mode. In this way, a single data storage circuit may be shared by, for example, processors having different data widths.

According to one aspect of the embodiments, a data processing apparatus may include a selection circuit that selects a first plurality of data bits from a memory array in a first mode and selects N times the first plurality of data bits from the memory array in a second mode wherein N is an integer of 2 or greater.

According to one aspect of the embodiments, the data processing apparatus may be included on a semiconductor device.

According to one aspect of the embodiments, the selection circuit may be coupled to a data bus for receiving at least the first plurality of data bits and coupled to a first and a second processor and the first processor has a different data width than the second processor.

According to one aspect of the embodiments, the data processing apparatus may further include a data write circuit the data write circuit may receive the plurality of decode signals and may write to memory cells storing the first plurality of data bits in the memory array in the first mode. The data write circuit may write to memory cells storing the N times the first plurality of data bits in the memory array in the second mode.

According to one aspect of the embodiments, the data processing apparatus may further include a data read circuit. The data read circuit may be coupled to receive the plurality of decode signals and may provide the first plurality of data bits from the memory array in the first mode and provide the N times the first plurality of data bits from the memory array in the second mode.

According to present invention, a data processing apparatus may include a memory array having a plurality of columns and rows of memory, a width-selection signal generating circuit that generates a width-selection signal having an n-bit width logic level and an m-bit width logic level, n being an integer greater than 1 and m being greater than n, a cell selecting circuit coupled to receive a plurality address bits and output a plurality of decode signals; and a data write circuit coupled to receive the plurality of decode signals and write the n-bit data to the memory array when the width-selection signal has the n-bit width logic level and the m-bit data into the memory array when the width-selection signal has the m-bit logic level.

According to one aspect of the embodiments, the cell selecting circuit may include a plurality of selector circuits, each selector circuit coupled to receive the width-selection signal and provide at least two decode signals of the plurality of decode signals.

According to one aspect of the embodiments, each selector circuit of the plurality of selector circuits may generate the at least two decode signals based on select signals and the width-selection signal and an activated one of the selector circuit provides a first number of active decode signals when the width-selection signal has the m-bit logic level and less than the first number of active decode signals when the width-selection signal has the n-bit logic level.

According to one aspect of the embodiments, the select signals may be provided by a decoder in accordance with at least a first and second address bit of the plurality of address bits.

According to one aspect of the embodiments, the plurality of selector circuits may include a first selector group and a second selector group that are selectable in accordance with a third address bit of the plurality of address bits.

According to the embodiments, a data processing apparatus may further include a data read circuit coupled to receive the plurality of decode signals and the n-bit data to the memory array when the width-selection signal has the n-bit width logic level and the m-bit data into the memory array when the width-selection signal has the m-bit logic level.

According to one aspect of the embodiments, each selector circuit of the plurality of selector circuits may generate the at least two decode signals based on select signals and the width-selection signal; and an activated selector circuit provides a first number of active decode signals when the width-selection signal has the m-bit logic level and less than the first number of active decode signals when the width-selection signal has the n-bit logic level.

According to one aspect of the embodiments, a data processing apparatus may further include a read/write switch circuit that switches on a read function or a write function.

According to another aspect of the embodiments, an address generating circuit may provide the plurality of address bits.

According to the embodiments, a data processing apparatus may include a memory array having a plurality of columns and rows of memory; a width-selection signal generating circuit that generates a width-selection signal having an n-bit width logic level and an m-bit width logic level; a cell selecting circuit coupled to receive a plurality of address bits and output a plurality of decode signals; and a data read circuit coupled to receive the plurality of decode signals and n-bit data to the memory array when the width-selection signal has the n-bit width logic level and m-bit data into the memory array when the width-selection signal has the m-bit logic level.

According to one aspect of the embodiments, the cell selecting circuit may include a plurality of selector circuits, each selector circuit coupled to receive the width-selection signal and provide at least two decode signals.

According to one aspect of the embodiments, the select signals may be provided by a decoder in accordance with at least a first and second address bit of the plurality of address bits.

According to one aspect of the embodiments, the data processing apparatus may be included on a semiconductor device.

According to one aspect of the embodiments, the plurality of selector circuits may include a first selector group and a second selector group that are selectable in accordance with a third address bit of the plurality of address bits.

According to one aspect of the embodiments, a data processing apparatus may further include a data write circuit coupled to receive the plurality of decode signals and write the n-bit data to the memory array when the width-selection signal has the n-bit width logic level and the m-bit data into the memory array when the width-selection signal has the m-bit logic level.

According to one aspect of the embodiments, a data processing apparatus may further include a read/write switch circuit that switches on a read function or a write function.

According to another aspect of the embodiments, the width selection signal may have an m-bit logic level and an n-bit logic level and m may be an integer multiple of n.

### BRIEF DESCRIPTION OF THE DRAWINGS

FIG. 1 is a block diagram of a data processing apparatus according to one embodiment.

FIG. 2 is a block diagram of a data storage circuit according to an embodiment.

FIG. 3 is a block diagram of a cell selecting circuit including a first and a second Y-decoder according to an embodiment.

FIG. 4 is a block diagram of a write circuit according to an embodiment.

FIG. 5 is a block diagram of a conventional data processing apparatus for selection of a corresponding data width.

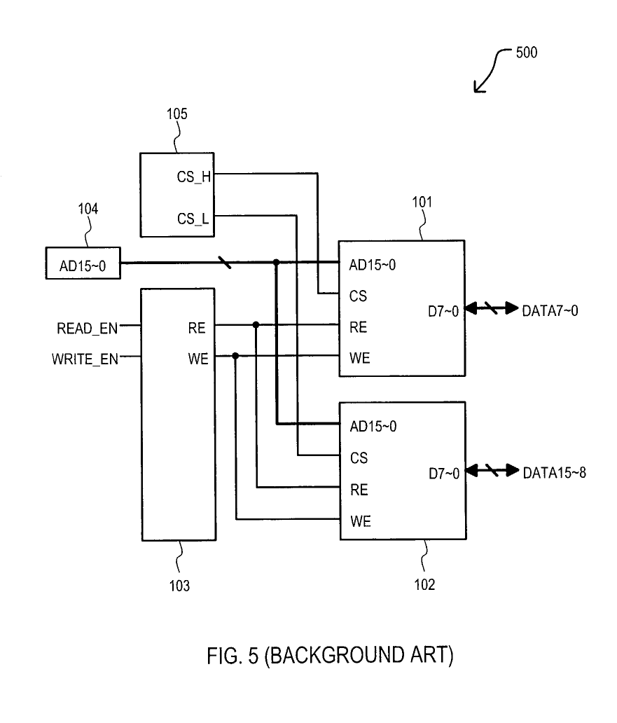

FIG. 6 is a block diagram of a conventional data storage circuit and a read/write switch circuit.

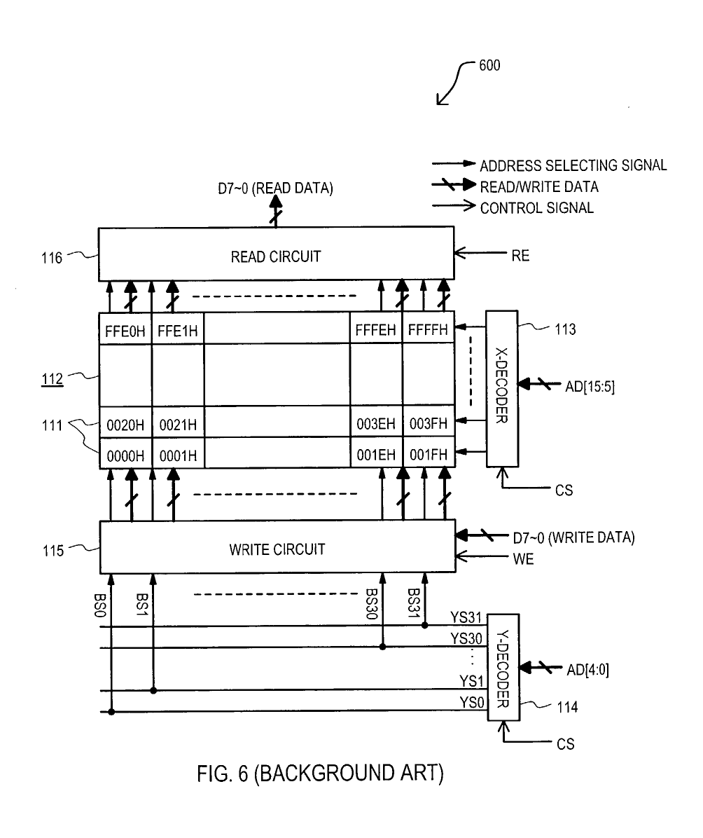

### DETAILED DESCRIPTION OF THE EMBODIMENTS

Various embodiments of the present invention will now be discussed in conjunction with a number of figures. The embodiments set forth apparatus and methods for providing varying data widths.

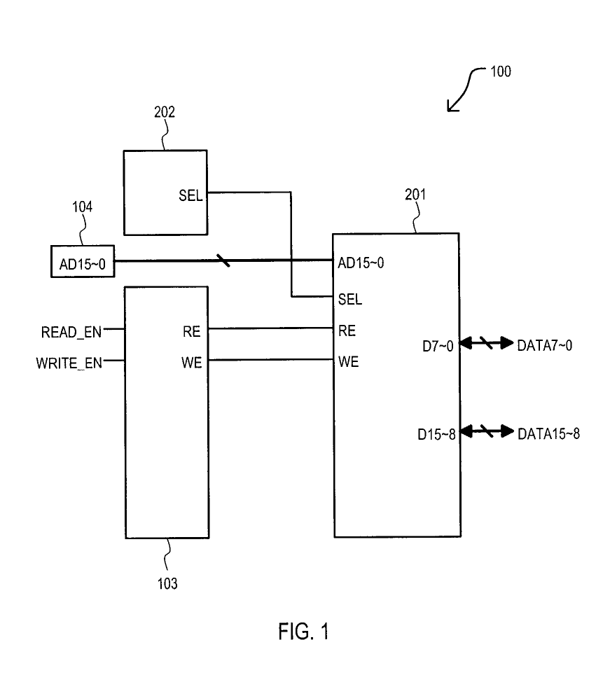

Referring now to FIG. 1, a data processing apparatus according to a first embodiment is set forth and designated by the general reference number 100. A data processing apparatus 100 may include a data storage circuit 201, a read/write switch circuit 103, an address generating circuit 104, and a selection signal generating circuit 202. Unlike a conventional data processing apparatus, a data processing apparatus 100 according to a first embodiment may include a single data storage circuit 201.

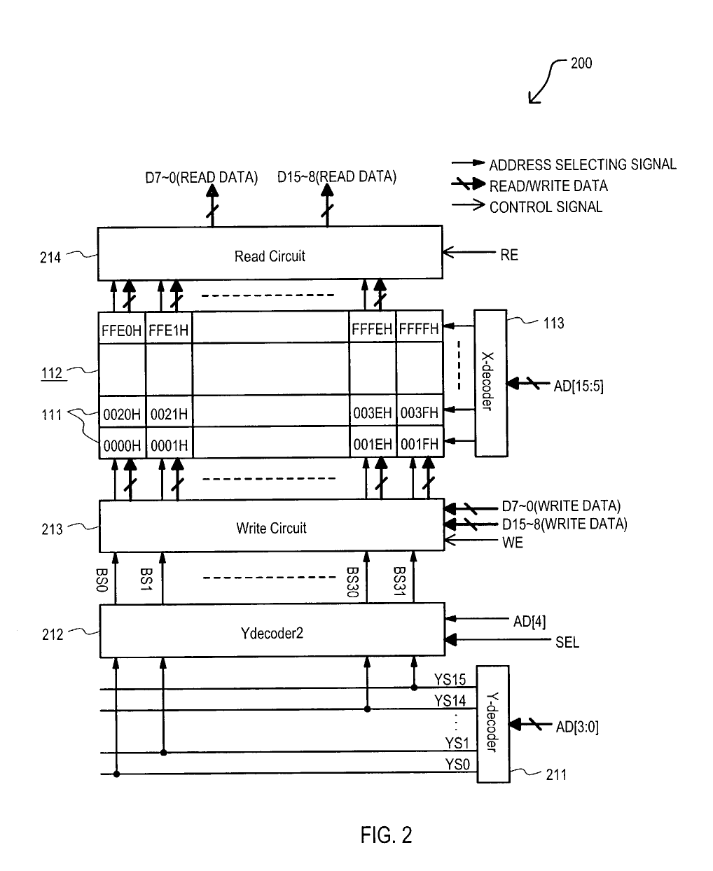

A data storage circuit 201 may each include a RAM array or an electrically erasable programmable read only memory array (EEPROM), or the like. A memory array may include rows and columns of memory cells and store data values. In addition, a data storage circuit 201 may input and output data values with an 8-bit width or a 16-bit width. Data values stored in a data storage circuit 201 may be available for reading and/or writing upon receiving a read enable RE or a write enable signal WE from a read/write switch circuit 103. A data storage circuit 201 will be described in more detail in FIG. 2.

A read/write switch circuit 103 may receive a read enable signal READ_EN and/or a write enable signal WRITE_EN and output either one accordingly. Thus, a read/write switch circuit 103 may selectively read and/or write data values from a data storage circuit 201 depending upon a type of enable signals that may be received. A read/write switch circuit 103 will be described in more detail in FIG. 2.

An address generating circuit 104 may be connected to a data storage circuit 201. An address generating circuit 104 may generate an address for each cell or entry of a memory array located on a data storage circuit 201. A typical address may be of a 16-bit size, for example. A data storage circuit 201 may receive an address from an address generating circuit 104 and select a corresponding memory cell on a memory array. An address output from an address generating circuit 104 may be received in parallel with an enable signals, such as a read enable RE and/or write enable WE by a data storage circuit 201.

A selection signal generating circuit 202 may generate and input a selection signal SEL to a data storage circuit 201. Unlike a conventional data process apparatus, a selection signal generating circuit 202 may generate a selection signal SEL to distinguish (designate) a data operation mode between an 8-bit mode and a 16-bit mode. When an 8-bit a data value is received, a selection signal SEL having a high logic level may be generated as an output to indicate that a process operation may be in an 8-bit mode. On the contrary, when a 16-bit data value is received, a selection signal SEL having a low logic level may be generated as an output to indicate that a process operation may be a 16-bit mode. In this way, a switch between an 8-bit mode and a 16-bit mode may be controlled by a selection signal SEL.

Unlike a conventional data processing apparatus, a selection signal generating circuit 202 may selectively control operations in a data storage circuit 201 by outputting a control signal SEL that may switch on a desired operation mode. In addition, only a single data storage circuit 201 may be utilized to process data values having differing widths of an input data.

Referring now to FIG. 2, a data storage circuit according to an embodiment is set forth and designated by the general reference number 200. Data storage circuit 200 may be used as data storage circuit 201 in FIG. 1.

A data storage circuit 200 may include at least one memory array 112, a cell selecting circuit including an X-decoder 113, a first Y-decoder 211, a second Y-decoder 212, a read circuit 213 and a write circuit 214. Unlike a conventional data storage circuit, a data storage circuit 200 according to one embodiment may include an additional second Y-decoder 212.

A memory array 112 may include a number of memory cells 111. Typically, a memory cell 111 on a memory array 112 may have a 2,048×32 layout, 2048 rows and 32 columns. Each memory cell 111 may have a unique address value ranging from 0000 to FFFF, for example. Each address value may correspond to a point value having both an X-axis and a Y-axis indication. Although illustrated as a memory cell 111, memory cells 111 may include, for example eight individual memory cells and may thus store an 8-bit data value.

An X-decoder 113 may select a row of memory cells 111 on a memory array 112. An X-decoder 113 may be connected between a memory array 112 and an address generating circuit 104.

An X-decoder 113 may receive an input of an address value from an address generating circuit 104 and decode it to select a row. An X-decoder 113, as a part of a cell selecting circuit, may select a row of memory cells 111 in accordance with a row address.

Decoded address values by an X-decoder 112 and a first Y-decoder 211 and a second Y-decoder 212 may be generated at different times during a data processing operation.

A cell selecting circuit may include a first Y-decoder 211 and a second Y-decoder 212. A first Y-decoder 211 and a second Y-decoder 212 may generate decoded column address values for memory cells 111 on a memory array 112. A first Y-decoder 211 and a second Y-decoder 212 may be connected between a memory array 112 and an address generating circuit 104. A first Y-decoder 211 and a second Y-decoder 212 may be also connected to a number of switch circuits for selecting and switching on a number of memory cells.

A first Y-decoder 211 and a second Y-decoder 212 may receive an address from an address generating circuit 104 and decode it to provide column decode signals. A column of memory cells 111 may be selected accordingly. A memory cell may thus be located by an activated row and column as decoded by an X-decoder 113 and Y-decoders 211 and 212, respectively.

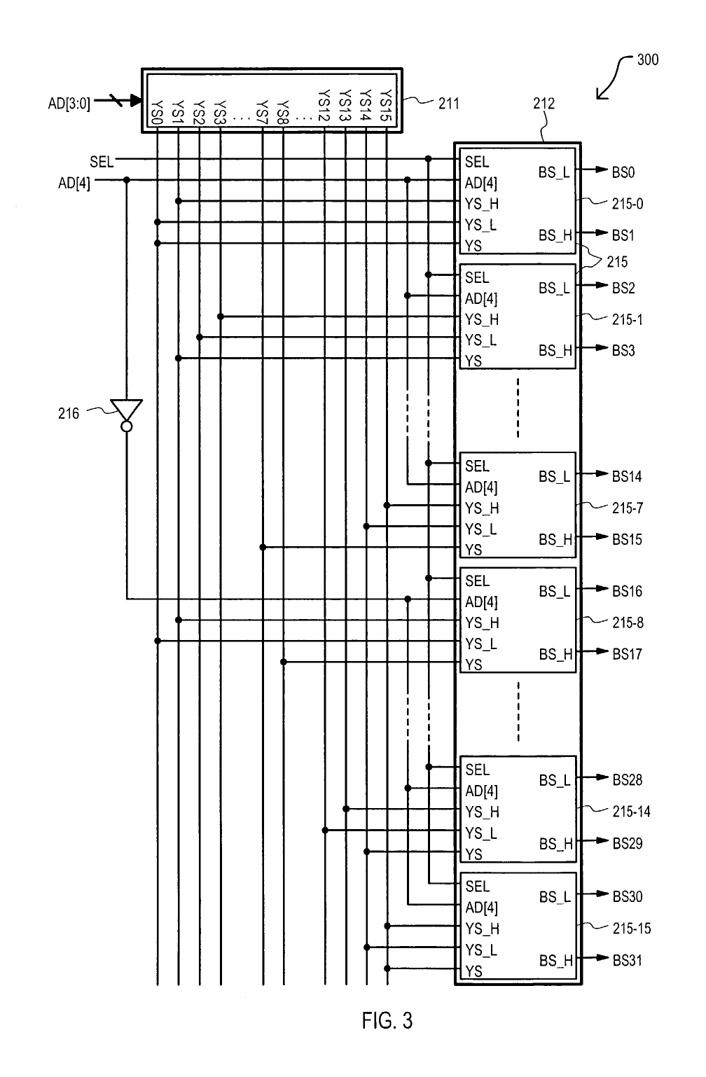

Unlike a conventional approach, a second Y-decoder 212 in a data storage circuit according to one embodiment of the present invention may receive a selection signal SEL from a selection signal generating circuit 202. Both a first and a second Y-decoder 211 and 212 may be involved in generating decode column signals. A second Y-decoder 212 and its operation may be described in more detail in FIG. 3.

In a particular arrangement, a memory cell 111 may have an address value having both an row address and column address components. Upon receiving an address from an address generating circuit 104, an X-decoder 113 may decode an 11-bit address value “AD[15:5]” as a lower order of 16-bit address bit “AD[15,0]” to 2048 (2¹¹) decoded values.

A data storage circuit 200 may further include a write circuit 213 and a read circuit 214. A write circuit 213 and a read circuit 214 may write data into or read data from a memory array 112, respectively. Depending upon whether a write-enable signal, WRITE_EN or a read-enable signal, READ_EN, is activate, a write circuit 213 or a read circuit 214, may be activated to write data into or read data from a memory cell 111.

Referring now to FIG. 3, a cell selecting circuit including a first and a second Y-decoder according to one embodiment are set forth and designated by the general reference number 300. A cell selecting circuit 300 may include a first Y-decoder 211 and a second Y-decoder 212. Unlike in a conventional approach, a cell selecting circuit 300 may include an additional second Y-decoder 212 that may selectively activate more than one column of memory cells according to the data width of a received data value.

A first Y-decoder 211 may output 16 select signals YS0-15. The 16 select signals may be divided into 8 groups. Each group of select signals may include a pair of adjacent select signals. Each select signal YS0-15 may be provided to a second Y-decoder 212.

For example, a first select signal group may include select signals YS0-YS1. A first select signal YS0 may be provided to second Y-decoder 212. A second select signal YS1 may be provided to second Y-decoder 212. Each select signal group may include a low order select signal and an high order select signal. For example first select output group, select signal YS0 may be considered low order select signal and select signal YS1 may be considered an high order select signal.

A first Y-decoder 211 may receive a data address value and output a decoded data address value (select output) to a second Y-decoder 212. In one particular embodiment, a first Y-decoder 211 may receive a data address value of 4-bits, AD [3:0]. A data address AD [3:0] may be further decoded to 16-bit factors. A first Y-decoder 211 may then output decoded 16-bit factors to a second Y-decoder 212 on 16 select outputs. It should be noted that only one of the 16-bit factors (select signals YS0 to YS15) may be active in accordance with an address value AD [3:0] received.

Having described a first Y-decoder 211, a second Y-decoder 212 will now be described.

A second Y-decoder 212 may include 16 byte selectors 215 (0-15). The 16 byte selectors 215 (0-15) may be connected to a memory array 112. A second Y-decoder 212 may output data values received from a first Y-decoder 211 to a cell memory 112 via 32 byte select signals BS0-BS31.

The 16 byte selectors 215 (0-15) may be divided into two groups. Each group of byte selectors may have 8 byte selectors, 215 (0-7) or 215 (8-15). A first group of 8 byte selectors 215-0 to 215-7 may be controlled by a fifth address bit control signal, AD[4]. A fifth address bit control signal AD[4] may also control a second group of 8 byte selectors 215-16 to 215-31 via an inverted signal AD [4]′ provided by an inverter 216.

Each byte selector 215 may include a set of select inputs and a set of select outputs. Values may be received from a first Y-decoder 211 to each byte selector 215 at a set of select inputs. At a set of select outputs, output selection address values from each byte selector 215 may be provided to allow selection of memory cells 111 on a memory array 112.

A set of select inputs may include five inputs, a selection signal input SEL, a fifth bit address input AD [4], a higher order select input YS_H, a lower order select input YS_L and a select input YS.

Byte selector (215-0 to 215-15) receive a select signal (YS0 to YS15) at select input YS. Select input YS may be enabled in a 16-bit operation mode. Select input YS may receive a select signal (YS0 to YS15). In a 16-bit operation mode, select signal (YS0 to YS15) received at select input YS may be output to both byte select outputs BS_L and BS_H. In an 8-bit operation mode, a select input YS may be disabled.

Each byte selector (215-0 to 215-7) in the first byte selector group may receive a group of select signals (YS0-YS1 to YS14-YS15), respectively. For each byte selector (215-0 to 215-7) a respective low order select signal (YS0, YS2, . . . , YS14) may be received at the low order select input YS_L and a respective high order select signal (YS1, YS3, . . . , YS14) may be received at the high order select input YS_H.

Likewise, each byte selector (215-8 to 215-15) in the second byte selector group may receive a group of select signals (YS0-YS1 to YS14-YS15), respectively. For each byte selector (215-8 to 215-15) a respective low order select signal (YS0, YS2, . . . , YS14) may be received at the low order select input YS_L and a respective high order select signal (YS1, YS3, . . . , YS14) may be received at the high order select input YS_H.

Each byte selector 215 may provide byte select outputs (BS_L and BS_H). Each byte selector 215 may be connected to select a pair of columns of memory cells in accordance with byte select outputs (BS_L and BS_H). Byte select output BS_L may select an even column, for example, of memory cells of a memory array 112. Byte select output BS_H may select an odd column, for example, of memory cells of a memory array 112. An even column and an odd column of memory cells selectable by byte select outputs (BS_L and BS_H) may be adjacent columns, for example.

In an 8-bit operation mode, either BS_L or BS_H may be active. A received select signal at select input YS_H may be output as byte select signal BS_H in an activated byte selector 215. A received select signal at select input YS_L may be output as byte select signal BS_L in an activated byte selector 215.

In a 16-bit operation mode, both byte select signals BS_L and BS_H may serve as a select output for data values received in select input YS.

A particular example of an operation involving a first Y-decoder 211 and a first byte selector in second Y-decoder 212 will now be described.

A first byte selector 215-0 may include five select inputs including a selection signal input SEL, a fifth bit address input AD [4], a lower order select input YS_L, a higher order select input YS_H, and a select input YS. A first byte selector 215-0 may include two select signals BS_L and BS_H that may be connected to an odd column and an even column memory cell. Similarly, a second byte selector 215-1 may include two select outputs BS2 and BS3 that may be connected to an odd column and an even column memory cells. An odd and an even column may be adjacent columns, for example.

Each byte selector 215 may receive a selection signal input SEL. A selection signal input SEL may be generated by a selection signal generating circuit 202 and universally applied to each byte selector 215. A selection signal input SEL may control whether an operation may be in an 8-bit mode or a 16-bit mode in all byte selectors 215.

A fifth bit address input AD [4] may determine whether an address has a fifth bit value. A fifth bit address may be “0” or “1”.

In an 8-bit mode, a lower order select input YS_L may receive a first select input from YS0 and output it to a lower order select input BS_L in a first byte selector 215-0. Similarly, a higher order select input YS_H may receive a select input from a second select input YS1 in a first Y-decoder 211 and output to a higher order select output BS_H in a first byte selector 215-0.

Thus, a lower order select output BS_L may select an even column 0 of memory cells in a memory array 112. A select output BS0 may select an even column 0 of memory cells. A higher order select output BS_H may select an odd column 1 of memory cells in a pair of memory cells (0-1) and output select output signal BS1 to a memory cell 1.

Another particular example of an operation involving a first Y-decoder 211 and an 8^{th} byte selector in a second Y-decoder 212 will now be described.

An 8th byte selector 215-7 may include a set of select inputs and select outputs. Select inputs may include a selection signal input SEL, a fifth bit address input AD [4], a lower order select input YS_L, a higher order select input YS_H and a select input YS that may receive a 16-bit data value. An 8th byte selector 215-7 may include select outputs BS_L and BS_H that may be connected to an even column 14 of memory cells and an odd column 15 of memory cells.

An input AD [4] may provide a fifth bit address value. A fifth bit address input AD [4] may be the same as that received in byte selectors 215-0 to 215-7. However, a fifth bit address input AD [4] may be different than that received in byte selectors 215-8 to 215-15. An inverter 216 may invert an initial fifth bit address input AD [4] to an input AD [4]′ and output it to byte selectors 215-8 to 215-15.

A selection signal SEL generated by a selection signal generating circuit 202 may control an operation mode. Whether a data processing operation is an 8-bit or a 16-bit may depend upon a selection signal SEL. As but one example, a selection signal SEL having a high logic level may indicate an 8-bit operation mode. A selection signal SEL having a low logic level may indicate a 16-bit operation mode.

A lower order select input YS_L may receive a select input from a fifteenth select input YS14 and select output YS14 to a lower order select input BS_L in an 8th byte selector 215-7. Similarly, a higher order select input YS_H may receive a select input from a sixteenth select input YS15 and output YS15 to a higher order select output BS_H in an 8th byte selector 215-7. Thus, a lower order select output BS_L may output BS14 to a memory cell 14. A higher order select output BS_H may output BS15 to a memory cell 15.

The relationship between a select input and its corresponding select output signal by a byte selector 215 will be illustrated in Truth Table 1.

TRUTH TABLE 1

| | Input | | | | | Output | |
|---|---|---|---|---|---|---|---|
| Mode | SEL | AD[4] | YS_H | YS_L | YS | BS_H | BS_L |
| 8-bit mode | 1 | 0 | 0 | 0 | 0 | 0 | 0 |
| | 1 | 0 | 0 | 1 | 0 | 0 | 0 |
| | 1 | 0 | 1 | 0 | 0 | 0 | 0 |
| | 1 | 0 | 0 | 0 | 1 | 0 | 0 |
| | 1 | 1 | 0 | 0 | 0 | 0 | 0 |
| | 1 | 1 | 0 | 1 | 0 | 0 | 1 |
| | 1 | 1 | 1 | 0 | 0 | 1 | 0 |
| | 1 | 1 | 0 | 0 | 1 | 0 | 0 |
| 16-bit mode | 0 | 0 | 0 | 0 | 0 | 0 | 0 |
| | 0 | 0 | 0 | 1 | 0 | 0 | 0 |
| | 0 | 0 | 1 | 0 | 0 | 0 | 0 |
| | 0 | 0 | 0 | 0 | 1 | 1 | 1 |
| | 0 | 1 | 0 | 0 | 0 | 0 | 0 |
| | 0 | 1 | 0 | 1 | 0 | 0 | 0 |
| | 0 | 1 | 1 | 0 | 0 | 0 | 0 |
| | 0 | 1 | 0 | 0 | 1 | 1 | 1 |

In an 8-bit mode operation, a byte selector 215 may receive a selection signal SEL having a high logic level. A YS column may be inoperative during an 8-bit mode operation. At any given time, there may be only one high select input of 16 select inputs YS (0-15) that may be received at a second Y-decoder 212. Thus, either select input YS_H or YS_L may have a data value “1”. When a fifth bit address bit input AD[4] is “1”, a lower select output BS_L may output a select input received from a lower order select input YS_L. Similarly, at another time, a higher order select output BS_H may output a select input “1” received from a higher order select input YS_H.

In a 16-bit mode operation, a byte selector 215 may receive a selection signal SEL having a low logic level. Both YS_H and YS_L columns may be inoperative during a 16-bit mode operation. A YS column may be active. A byte selector 215 may receive a select input YS “1” and output to both select outputs BS_H and BS_L.

Having described structural components of a cell selecting circuit including a first and a second Y-decoder 211 and 212 according to one embodiment 300, an operation will now be described.

In a particular embodiment, when it receives a 4-bit column address AD [3:0], a first Y decoder 211 may decode AD [3:0] into a 16-bit decode value (YS0-YS15). A second Y-decoder 212 may further decode a 16-bit decode signal to a 32-bit decode value (BS0-31) by using a fifth bit address value AD[4].

A fifth bit address value AD[4] may be inputted to first 8 byte selectors 215 (0-7) and inverted AD[4]′ may be inputted to second 8 byte selectors 215 (8-15). When a fifth bit address value is “1”, first 8 byte selectors 215 may receive bit value “1” and second 8 byte selectors 215 (8-15) may received an inverted fifth address value “0”.

In this way, when a selection signal generating circuit 202 generates a selection signal SEL that indicates an 8-bit operation mode, a second Y-decoder 212 may generate a column address corresponding to one column from 32 columns on a memory array 112. An X-decoder 113 may generate a row address that corresponds to a row in a memory array 112. Thus, a pair of row and column addresses may correspond to a single memory cell 111 on a memory array 112. In this way, a memory cell 111 may be selected.

On the other hand, when a selection signal generating circuit 202 generates a selection signal SEL that indicates a 16-bit operation mode, a second Y-decoder 212 may generate a column address corresponding to two columns from 32 columns on a memory array 112. An X-decoder 113 may generate a row address that corresponds to a row in a memory array 112. A byte selector 215 may receive a select input YS and output it to two select outputs BS_H and BS_L. Thus, a pair of row and column address values may correspond to a single memory cell on a memory array 112. In this way, a memory cell storing a 16-bit data value may be selected.

A write circuit 213 may write data values to a selected memory cell 111 on a memory array 112. A read circuit 214 may read data values stored in a selected memory cell 111 and output the read data values.

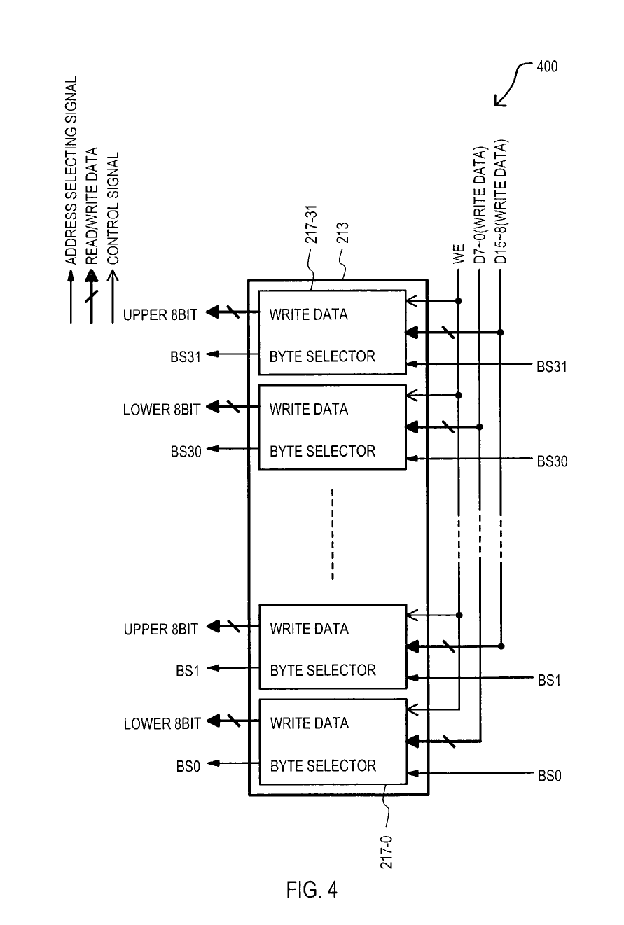

Referring now to FIG. 4, a write circuit according to one embodiment is set forth and designated by the general reference number 400. A write circuit according to one embodiment 400 may include 32 individual writing circuits 217 (0-31). A write circuit 400 may be connected to a memory array 112.

Each individual writing circuit 217 (0-15) may include a byte selector BYTE SELECTOR and a data writing circuit WRITE DATA. A byte selector BYTE SELECTOR and a data writing circuit WRITE DATA may be connected to a memory array 112. An even-numbered byte selector BYTE SELECTOR may be connected to a corresponding even number column in a 32-column memory array 112. Similarly, an odd number byte selector BYTE SELECTOR may be connected to a corresponding odd number column in a 32-column memory array 112. As but one example, a first byte selector 0 may be connected to a first column of a memory array 112. A second byte selector 1 may be connected to a second column of a memory array 112.

Having described a writing circuit 400, a write operation will now be described in detail.

Each individual writing circuit 217 (0-31) may receive a write command WE, a select input BS, an 8-bit D7-0 lower order of a 16-bit data value or an 8-bit upper D15-8 lower order of a 16-bit data value. All 32 individual writing circuits 217 (0-31) may be divided into 16 groups. Each group may include a pair of byte selectors. A pair of byte selectors may include an even number one and an odd number one. Typically, an even number byte selector in a pair may be a lower order one; an odd number byte selector in a pair may be a higher order one.

In particular arrangements, an even number writing circuit may receive an 8-bit D7-0 lower order of a 16-bit data value and an odd number a writing circuit may receive an 8-bit D15-8 upper order of a 16-bit data value. More specifically, an 8-bit D7-0 lower order of a 16-bit data value may be transmitted over to a lower order byte selector in a pair of byte selectors. An 8-bit D15-8 upper order of a 16-bit data value may be transmitted over to an upper order of byte selector in a pair of byte selectors.

In this way, an even number writing circuit may output an 8-bit D7-0 lower order of a 16-bit data value to an even number column on a memory array 112. Similarly, an odd number writing circuit may output an 8-bit D15-8 upper order of a 16-bit data value.

For example, an 8-bit D7-0 lower order of a 16-bit data value may be generated. Upon receiving a write command WE, all even number individual writing circuits 217 (0-14) may receive and output an 8-bit D7-0 lower order of a 16-bit data value to all even number columns 0-30 on a memory array 112. Similarly, an 8-bit D15-7 upper order of a 16-bit data value may be generated and received by all odd number individual writing circuits 217 (1-31). All odd number individual writing circuits 217 (1-31) may output an 8-bit D15-7 upper order of a 16-bit data value to all odd number columns 1-31 on a memory array 112.

A write operation may operate either in an 8-bit mode or a 16-bit mode. Depending upon a selection signal SEL that may be received at a byte selector, a write operation may perform an 8-bit mode or a 16-bit mode operation.

For example, a write operation may perform an 8-bit mode when a selection signal SEL having a high logic level is received. Only one column on a memory array 112 may be selected to receive an 8-bit data value. On the other hand, a write operation may perform a 16-bit mode when a selection signal SEL having a low logic level is received. Two adjacent columns on a memory array 112 may be selected to process a 16-bit data value, for example.

Unlike a conventional circuit, a single data storage circuit may read or write 8-bit and 16-bit data values. The number of circuits may be significantly reduced and significant. Therefore, a data storage circuit according to embodiments of the present invention may increase data processing efficiency.

It is also understood that an operation circuit may receive a data value with more than 16-bit. An 8n-bit operation mode with data values having N times of a minimum 8-bit size (8n-bit) may also be controlled by a selection signal SEL. A cell selecting circuit may select N-number columns in a memory array 112 to receive 8n-bit of data values. In addition, a minimum data bit may be more or less than 8-bit as illustrated in the particular embodiments of present inventions. Furthermore, a memory array can include a plurality of sub-arrays, as just an example.

Thus, while the embodiments set forth herein have been described in detail, it should be understood that the present invention could be subject to various changes, substitutions, and alterations without departing from the spirit and scope of the invention. The present invention may not be limited to the above embodiments and may vary without departing from the essence of the present invention. Accordingly, the present invention is intended to be limited only as defined by the appended claims.

What is claimed is:

1. A data processing apparatus, comprising:
a selection circuit that selects a first plurality of data bits from a memory array in a first mode and selects N times the first plurality of data bits from the memory array in a second mode wherein N is an integer of 2 or greater.

2. The data processing apparatus of claim 1, wherein:
the data processing apparatus is included on a semiconductor device.

3. The data processing apparatus of claim 1, wherein:
the selection circuit is coupled to a data bus for receiving at least the first plurality of data bits and coupled to a first and a second processor and the first processor has a different data width than the second processor.

4. The data process apparatus of claim 1 wherein the selection circuit provides a plurality of decode signals, the data processing apparatus further including:
a data write circuit coupled to receive the plurality of decode signals and writes to memory cells storing the first plurality of data bits in the memory array in the first mode and writes to memory cells storing the N times the first plurality of data bits in the memory array in the second mode.

5. The data process apparatus of claim 1 wherein the selection circuit provides a plurality of decode signals, the data processing apparatus further including:
a data read circuit coupled to receive the plurality of decode signals and provide the first plurality of data bits from the memory array in the first mode and provide the N times the first plurality of data bits from the memory array in the second mode.

6. A data processing apparatus, comprising:
a memory array having a plurality of columns and rows of memory cells;
a width-selection signal having an n-bit width logic level and an m-bit width logic level, n being an integer greater than 1 and m being greater than n;
a cell selecting circuit coupled to receive a plurality of address bits and output a plurality of decode signals; and
a data write circuit coupled to receive the plurality of decode signals and write n-bit data to the memory array when the width-selection signal has the n-bit width logic level and m-bit data into the memory array when the width-selection signal has the m-bit logic level.

7. The data processing apparatus of claim 6, wherein:
the cell selecting circuit includes a plurality of selector circuits, each selector circuit coupled to receive the width-selection signal and provide at least two decode signals of the plurality of decode signals.

8. The data processing apparatus of claim 7, wherein:
each selector circuit of the plurality of selector circuits generates the at least two decode signals based on select signals and the width-selection signal; and
an activated selector circuit of the plurality of selector circuits provides a first number of active decode signals when the width-selection signal has the m-bit logic level and less than the first number of active decode signals when the width-selection signal has the n-bit logic level.

9. The data processing apparatus of claim 8, wherein:
a decoder provides the select signals in accordance with at least a first and second address bit of the plurality of address bits.

10. The data processing apparatus of claim 7, wherein:
the plurality selector circuits include a first selector group and a second selector group that are selectable in accordance with a third address bit of the plurality of address bits.

11. The data processing apparatus of claim 6, further including:
a width-selection signal generating circuit the generates the width-selection signal.

12. The data processing apparatus of claim 6, wherein:
n is eight and m is an integer multiple of eight.

13. The data processing apparatus of claim 6, further including:
an address generating circuit coupled to provide the plurality of address bits.

14. A data processing apparatus, comprising:
a memory array having a plurality of columns and rows of memory cells;
a width-selection signal having an n-bit width logic level and an m-bit width logic level, n being an integer greater than 1 and m being greater than n;
a cell selecting circuit coupled to receive a plurality of address bits and output a plurality of decode signals; and
a data read circuit coupled to receive the plurality of decode signals and n-bit data to the memory array when the width-selection signal has the n-bit width logic level and m-bit data into the memory array when the width-selection signal has the m-bit logic level.

15. The data processing apparatus of claim 14, wherein:
the cell selecting circuit includes a plurality of selector circuits, each selector circuit coupled to receive the width-selection signal and provide at least two decode signals of the plurality of decode signals.

16. The data processing apparatus of claim 15, wherein:
each selector circuit of the plurality of selector circuits generates the at least two decode signals based on select signals and the width-selection signal; and
an activated selector circuit of the plurality of selector circuits provides a first number of active decode signals when the width-selection signal has the m-bit logic level and less than the first number of active decode signals when the width-selection signal has the n-bit logic level.

17. The data processing apparatus of claim 15, wherein:
the plurality of selector circuits include a first selector group and a second selector group that are selectable in accordance with a third address bit of the plurality of address bits.

18. The data processing apparatus of claim 14, wherein:
the data processing apparatus is included on a semiconductor device.

19. The data processing apparatus of claim 14, further including:
a data write circuit coupled to receive the plurality of decode signals and write the n-bit data to the memory array when the width-selection signal has the n-bit width logic level and the m-bit data into the memory array when the width-selection signal has the m-bit logic level.

20. The data processing apparatus of claim 14, wherein:
m is an integer multiple of n.
